(19) United States
(12) Patent Application Publication
(10) Pub. No.: US 2024/0281304 A1
(43) Pub. Date: Aug. 22, 2024

(54) EFFICIENT AND DYNAMIC CORE ASSIGNMENT BASED ON INHERENT CORE CHARACTERISTICS

(71) Applicant: Intel Corporation, Santa Clara, CA (US)

(72) Inventors: Subham Sarda, Siliguri (IN); Anil B Lingambudi, Bendaluru (IN); Manickam Saravanan, Bangalore (IN)

(21) Appl. No.: 18/171,444

(22) Filed: Feb. 20, 2023

(51) Int. Cl. G06F 9/50

(52) U.S. Cl. CPC G06F 9/5094; G06F 9/5044; G06F 9/505

(57) ABSTRACT

Embodiments described herein may include apparatus, systems, techniques, and/or processes that are directed to techniques for workload balancing in a computing system with heterogeneous processing engines. A core assignment optimizer selects one or more of the heterogeneous processing engines based on static and heuristic profiling. Static factors considered may include user preferences, system capabilities including maximum power consumption and thermals, the workload type and the unique power/performance profile of each heterogeneous processing engine and the like. Dynamic or heuristic factors may include processing engine usage over time, current thermal characteristics of the system, current system workload including resource availability, and the like.

### TECHNICAL FIELD

Embodiments of the present disclosure generally relate to the field of computing, in particular, to load balancing in a heterogeneous core computing system.

### BACKGROUND

The complexity of computing systems continues to increase at a fast pace. Today's computing systems may include an increasing number of devices, including devices with multiple processing units, input/output (I/O) devices, system on a chip (SoC) devices, multiple die packaged in a single device, and the like. The increasing number of devices consume an increasing amount of power. Assigning workloads to processing engines is complex due to system power and performance constraints. Further complexity is introduced with the use of heterogeneous processing engines, each with their own power/performance profile. Workload balancing and achieving maximum performance while also achieving the lowest energy footprint becomes much more complex.

Many systems today allow a user to choose between performance and energy efficiency or even a balance between the two, without any understanding of the underlying hardware. Other systems rely on workload classifications and assign those workloads to the most favorable cores with only basic understanding of each cores unique capabilities. Other systems rely on an application developer to assign Quality of Service (QoS) classifications which, if assigned, do not take into account hardware feedback or system characteristics such as the power/performance profiles of each processing engine.

A solution is needed that takes full advantage of the unique characteristics of a computing system with multiple heterogeneous cores providing optimum performance and power efficiency.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates a computing system in accordance with various embodiments.

FIG. 2 illustrates another computing system in accordance with various embodiments.

FIG. 3 illustrates another computing system in accordance with various embodiments.

FIG. 4 illustrates a core selection flow in accordance with various embodiments.

### DETAILED DESCRIPTION

Embodiments described herein may include apparatus, systems, techniques, and/or processes that are directed to techniques for workload balancing in a computing system with heterogeneous processing engines. A core assignment optimizer selects one or more of the heterogeneous processing engines based on static and heuristic profiling. Static factors considered may include user preferences, system capabilities including maximum power consumption and thermals, the workload type and the unique power/performance profile of each heterogeneous processing engine and the like. Dynamic or heuristic factors may include processing engine usage over time, current thermal characteristics of the system, current system workload including resource availability, and the like.

In the following description, various aspects of the illustrative implementations will be described using terms commonly employed by those skilled in the art to convey the substance of their work to others skilled in the art. However, it will be apparent to those skilled in the art that embodiments of the present disclosure may be practiced with only some of the described aspects. For purposes of explanation, specific numbers, materials, and configurations are set forth in order to provide a thorough understanding of the illustrative implementations. It will be apparent to one skilled in the art that embodiments of the present disclosure may be practiced without the specific details. In other instances, well-known features are omitted or simplified in order not to obscure the illustrative implementations.

In the following detailed description, reference is made to the accompanying drawings that form a part hereof, wherein like numerals designate like parts throughout, and in which is shown by way of illustration embodiments in which the subject matter of the present disclosure may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C).

The description may use perspective-based descriptions such as top/bottom, in/out, over/under, and the like. Such descriptions are merely used to facilitate the discussion and are not intended to restrict the application of embodiments described herein to any particular orientation.

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

The term “coupled with,” along with its derivatives, may be used herein. “Coupled” may mean one or more of the following. “Coupled” may mean that two or more elements are in direct physical or electrical contact. However, “coupled” may also mean that two or more elements indirectly contact each other, but yet still cooperate or interact with each other, and may mean that one or more other elements are coupled or connected between the elements that are said to be coupled with each other. The term “directly coupled” may mean that two or more elements are in direct contact.

As used herein, the term “module” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable components that provide the described functionality.

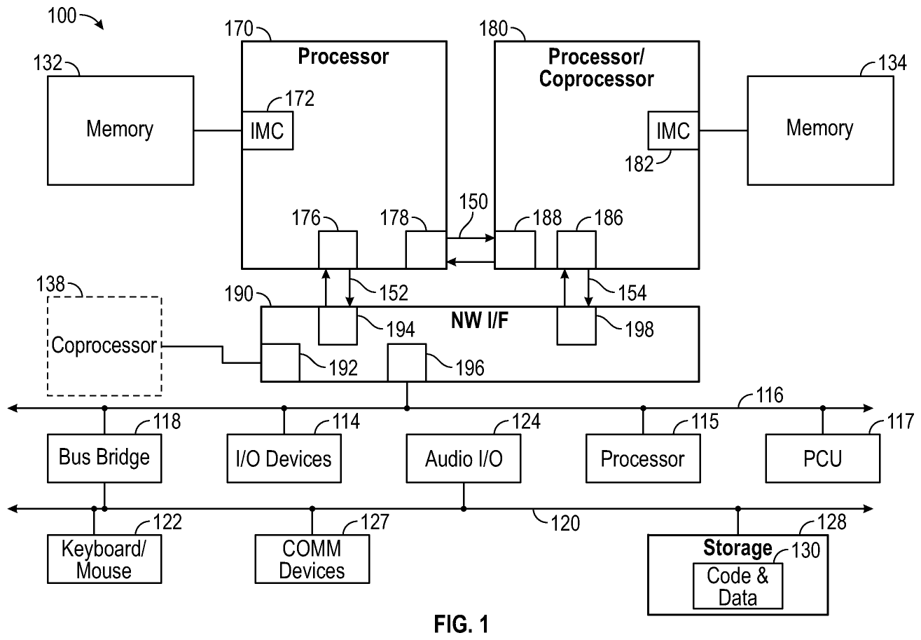

FIG. 1 illustrates a computing system in accordance with various embodiments. Multiprocessor system 100 is an interfaced system and includes a plurality of processors or cores including a first processor 170 and a second processor 180 coupled via an interface 150 such as a point-to-point (P-P) interconnect, a fabric, and/or bus. In some examples, the first processor 170 and the second processor 180 are homogeneous. In some examples, first processor 170 and the second processor 180 are heterogeneous with respect to each other. Though the example system 100 is shown to have two processors, the system may have three or more processors, or may be a single processor system. In some examples, the computing system is a system on a chip (SoC).

Processors 170 and 180 are shown including integrated memory controller (IMC) circuitry 172 and 182, respectively. Processor 170 also includes interface circuits 176 and 178; similarly, second processor 180 includes interface circuits 186 and 188. Processors 170, 180 may exchange information via the interface 150 using interface circuits 178, 188. IMCs 172 and 182 couple the processors 170, 180 to respective memories, namely a memory 132 and a memory 134, which may be portions of main memory locally attached to the respective processors.

Processors 170, 180 may each exchange information with a network interface (NW I/F) 190 via individual interfaces 152, 154 using interface circuits 176, 194, 186, 198. The network interface 190 (e.g., one or more of an interconnect, bus, and/or fabric, and in some examples is a chipset) may optionally exchange information with a coprocessor 138 via an interface circuit 192. In some examples, the coprocessor 138 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 170, 180 or outside of both processors, yet connected with the processors via an interface such as P-P interconnect, such that either or both processors' local cache information may be stored in the shared cache if a processor is placed into a low power mode.

Network interface 190 may be coupled to a first interface 116 via interface circuit 196. In some examples, first interface 116 may be an interface such as a Peripheral Component Interconnect (PCI) interconnect, a PCI Express interconnect or another I/O interconnect. In some examples, first interface 116 is coupled to a power control unit (PCU) 117, which may include circuitry, software, and/or firmware to perform power management operations with regard to the processors 170, 180 and/or co-processor 138. PCU 117 provides control information to a voltage regulator (not shown) to cause the voltage regulator to generate the appropriate regulated voltage. PCU 117 also provides control information to control the operating voltage generated. In various examples, PCU 117 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 117 is illustrated as being present as logic separate from the processor 170 and/or processor 180. In other cases, PCU 117 may execute on a given one or more of cores (not shown) of processor 170 or 180. In some cases, PCU 117 may be implemented as a microcontroller (dedicated or general-purpose) or other control logic configured to execute its own dedicated power management code, sometimes referred to as P-code. In yet other examples, power management operations to be performed by PCU 117 may be implemented externally to a processor, such as by way of a separate power management integrated circuit (PMIC) or another component external to the processor. In yet other examples, power management operations to be performed by PCU 117 may be implemented within BIOS or other system software.

Various I/O devices 114 may be coupled to first interface 116, along with a bus bridge 118 which couples first interface 116 to a second interface 120. In some examples, one or more additional processor(s) 115, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 116. In some examples, second interface 120 may be a low pin count (LPC) interface. Various devices may be coupled to second interface 120 including, for example, a keyboard and/or mouse 122, communication devices 127 and storage circuitry 128. Storage circuitry 128 may be one or more non-transitory machine-readable storage media as described below, such as a disk drive or other mass storage device which may include instructions/code and data 130. Further, an audio I/O 124 may be coupled to second interface 120. Note that other architectures than the point-to-point architecture described above are possible. For example, instead of the point-to-point architecture, a system such as multiprocessor system 100 may implement a multi-drop interface or other such architecture.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

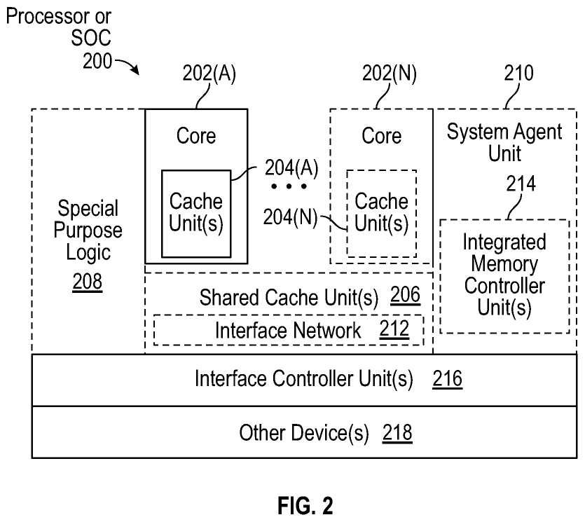

FIG. 2 illustrates another computing system in accordance with various embodiments. An SoC 200 that may have one or more cores and an integrated memory controller. The solid lined boxes illustrate an SoC 200 with a single core 202(A), system agent unit circuitry 210, and a set of one or more interface controller unit(s) circuitry 216, while the optional addition of the dashed lined boxes illustrates an alternative processor 200 with multiple cores 202(A)-(N), a set of one or more integrated memory controller unit(s) circuitry 214 in the system agent unit circuitry 210, and special purpose logic 208, as well as a set of one or more interface controller units circuitry 216. Note that the processor 200 may be one of the processors 170 or 180, or co-processor 138 or 115 of FIG. 1.

Thus, different implementations of the processor 200 may include: 1) a CPU with the special purpose logic 208 being integrated graphics and/or scientific (throughput) logic (which may include one or more cores, not shown), and the cores 202(A)-(N) being one or more general purpose cores (e.g., general purpose in-order cores, general purpose out-of-order cores, or a combination of the two); 2) a coprocessor with the cores 202(A)-(N) being a large number of special purpose cores intended primarily for graphics and/or scientific (throughput); and 3) a coprocessor with the cores 202(A)-(N) being a large number of general purpose in-order cores. Thus, the processor 200 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 200 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 204(A)-(N) within the cores 202(A)-(N), a set of one or more shared cache unit(s) circuitry 206, and external memory (not shown) coupled to the set of integrated memory controller unit(s) circuitry 214. The set of one or more shared cache unit(s) circuitry 206 may include one or more mid-level caches, such as level 2 (L2), level 3 (L3), level 4 (L4), or other levels of cache, such as a last level cache (LLC), and/or combinations thereof. While in some examples interface network circuitry 212 (e.g., a ring interconnect) interfaces the special purpose logic 208 (e.g., integrated graphics logic), the set of shared cache unit(s) circuitry 206, and the system agent unit circuitry 210, alternative examples use any number of well-known techniques for interfacing such units. In some examples, coherency is maintained between one or more of the shared cache unit(s) circuitry 206 and cores 202(A)-(N). In some examples, interface controller units circuitry 216 couple the cores 202 to one or more other devices 218 such as one or more I/O devices, storage, one or more communication devices (e.g., wireless networking, wired networking, etc.), etc.

In some examples, one or more of the cores 202(A)-(N) are capable of multi-threading. The system agent unit circuitry 210 includes those components coordinating and operating cores 202(A)-(N). The system agent unit circuitry 210 may include, for example, power control unit (PCU) circuitry and/or display unit circuitry (not shown). The PCU may be or may include logic and components needed for regulating the power state of the cores 202(A)-(N) and/or the special purpose logic 208 (e.g., integrated graphics logic). The display unit circuitry is for driving one or more externally connected displays.

The cores 202(A)-(N) may be homogenous in terms of instruction set architecture (ISA). Alternatively, the cores 202(A)-(N) may be heterogeneous in terms of ISA; that is, a subset of the cores 202(A)-(N) may be capable of executing an ISA, while other cores may be capable of executing only a subset of that ISA or another ISA.

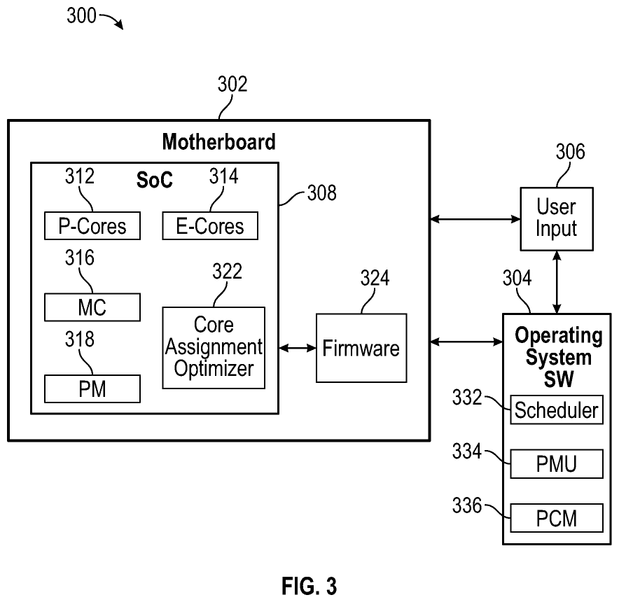

FIG. 3 illustrates another computing system in accordance with various embodiments. Computing system 300 includes a motherboard 302 and operating system software (OS) 304, both of which receive user input on operational preferences 306. Motherboard 302 includes one or more SoCs 308 including one or more performance cores (P-Cores) 312, one or more energy efficient cores (E-Cores) 314, microcontroller (MC) 316, power management unit (PM) 318, and core assignment optimizer (CAO) 322. Microcontroller 316 and power management unit 318 perform various activities, monitoring core usage and system thermals, managing power usage, and the like. Core assignment optimizer 322 assists in core assignment, taking into consideration multiple core power/performance profiles and static and heuristic system conditions, OS 304 recommendations, and user input 306.

Motherboard 302 also includes a firmware stack 324. Firmware stack 324 typically includes code stored on read only memory (ROM) or write-protected memory and has non-volatile characteristics. Firmware stack 324 encompasses multiple types of software, including BIOS, firmware image, portable code (P-Code), microcode (U-Code), and the like. SoC 308 interacts with firmware stack 324 at the board level, with the OS 304 at the system level, and the end user via user input 306.

Although FIG. 3 illustrates motherboard 302 as a single unit, motherboard 302 may have any configuration, for example, spread across multiple boards and/or SoCs, include additional components and the like. Although P-Cores 312 and E-Cores 314 are illustrated, more types of cores with differing power and performance profiles may be included.

OS 304 receives user input 306 indicating the user's preference for performance or power efficiencies. OS 304 may provide a user to select beyond the generic high/balanced/low setting and may allow the user to tweak the parameters of their interest. OS 304 includes a scheduler 332, power management utility (PMU) 334, and OS processor capabilities manager (PCM) 336 that coordinates and recommends core usage for single-thread and multi-thread workloads based on user input 306, system capacity, feedback from motherboard 302 and the like.

In accordance with various embodiments, P-Cores 312 and E-Cores 314 each have different efficiency and performance profiles, which may be used to identify a suitable core allocation profile prepared and applied in core selection for user visible benefits. A power and performance profile may include multiple operation conditions including system usage (idle, full workloads, and the like), workload type (single or multi-thread), various operating speeds and voltages, number of cores handling a workload, and the like resulting in complex scenarios to be analyzed and incorporated into load balancing evaluations. For example, for a multi-thread workload, it may be more optimum to assign the workload to four energy-efficient processing engines (E-Cores) rather than a single high-performance processing engine (P-Core). According to various embodiments, a power and performance profile for a core may be stored in any format, include any number of characteristics. By analyzing various power and performance profiles of different cores and other system characteristics and conditions, core assignment optimizer 322 may select the most optimum core for a particular task or thread.

Core assignment optimizer 322 may optimize load balancing between P-Cores 312 and E-Cores 314 while keeping the operations power efficient. Power consumption is another parameter to be considered, for example how well SoC 308 performs under stress, as it eventually controls the energy consumed and impacts the total operating cost. Core assignment optimizer 322 may initially perform core selection/assignment based on the user requirements and other inputs. Core assignment optimizer 322 may tweak the assignments dynamically based on hardware resource availability while providing the best performance within the given power budget and improving the performance per watt as well as the longevity of SoC 308. Core assignment optimizer 322 may adjust assignments to avoid overuse of one core or class of cores over the other(s). Core assignment optimizer 322 may first consider the initial setting by the user for performance or power and adjust the assignments based on system conditions, core parameters, and the like over time.

For any workload that runs on a hybrid architecture, the workload may be scheduled on P-cores 312 and/or E-cores 314 based on the performance required and the power budget. The P-Code in firmware stack 324 may perform core profiling based on parameters like thermals, efficiency, reliability and fault tolerance. Feedback may be provided to PMU 334 and/or core assignment optimizer 322 via advanced configuration and power interface (ACPI) tables to enable scheduling or switching the workload from one core or module to another based on differing characteristics and parameters such as single-thread/multi-thread workloads, short or long running job and the like. By analyzing the different power profiles of each core statistically, core assignment optimizer 322 may best optimize core assignment and usage. User input 306 may select between a performance or power-oriented setting at a deeper granularity than what is available in OS today, for the same available hybrid cores, which will then work in the background to optimize the usage and allocation of cores in a hybrid core architecture.

Microcontroller 316 and power management unit 318 of SoC 308 may measure parameters such as fault tolerance and reliability relative to thermal aging of a core over a period based on telemetry data and accordingly, perform heuristic profiling for the selection of the optimal core for a workload.

Core assignment optimizer 322 may use specific configuration of motherboard 302 to balance power efficiency relative to performance and workload type, in that, the net power consumed by 1 P-Core may be less than 4 E-Cores. On the other hand, increasing P-Core count by 1 more could change the equation. P-Cores and E-Cores may be optimized at different efficiency points (performance/power) with P-Cores being more efficient at higher power and E-Cores being more efficient at lower power. The cross-over between the two core types depends on the product configuration. For example, multi-threaded (MT) performance may be improved by using E-Cores that are optimized for performance per mm². If E-Cores have better MT performance per mm² than P-Cores, systems with hybrid or heterogeneous cores allows for better performance with higher energy efficiencies and allows core performance to be optimized across different workloads.

By considering power/performance profiles of the cores, the best-in-class performance per watt may be achieved. For example, in situations where users need performance but at the same time cannot afford to damage the SoC to meet the performance requirements or drain the battery of the computing system, system characteristics may be used to select the most optimal core for each workload.

Although described as P-Cores and E-Cores in computing system 300, a system with any number and type of heterogeneous cores may benefit from techniques disclosed herein. Heterogeneous cores may be described as cores with differing capabilities such as throughput, instructions per cycle, wattage use, thermal results, power envelope, instruction set capabilities, and the like resulting in different power and performance profiles.

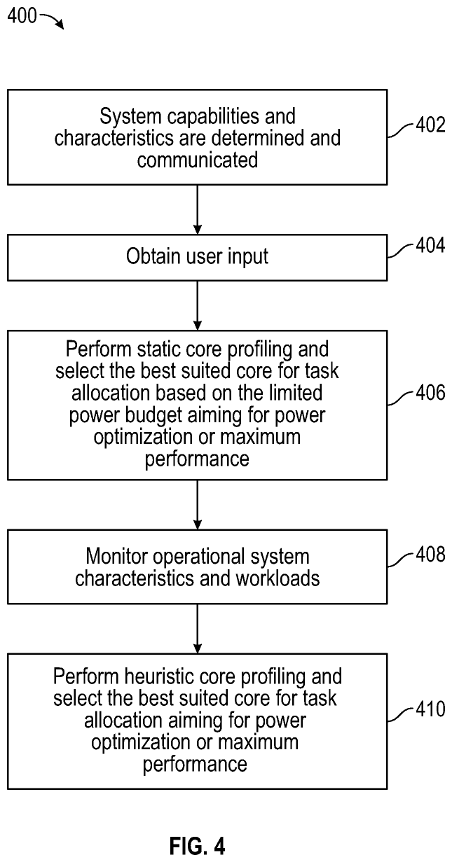

FIG. 4 illustrates a core selection flow 400 in accordance with various embodiments. Upon system boot, system firmware determines and communicates system capabilities and characteristics, block 402. System firmware may update the CPUID feature enumeration flags to indicate feature availability. This may be via a BIOS controllable option for the user. The system firmware may extract the core topology, capabilities, and other characteristics (for example core count, operating frequency, favored core and the like) and make these features known to the operating system software, for example, via ACPI tables stored in firmware.

Once the system boots to OS, the user may provide operating preferences using, for example, the processor capabilities module (PCM 336) or other input application to select the preferred power profile and operating margins of the SoC, block 404. According to various embodiments, more granular user selection may occur if the OS software recognizes the capabilities of the SoC and provides user selection options accordingly. Such user inputs may include power/performance preferences, workload selection and if available, fine tuning selections such as core operational speeds and/or operating voltages according to various embodiments. User selections may be fed back to the system FW controlling those parameters.

System firmware performs static profiling to select the best core for power efficient or power maximization operation, block 406. System firmware may use these parameters to characterize each core based on efficiency versus performance. If the user selection of parameters are within the non-violating region, the system firmware may apply the constraints and use the power optimization equations or performance maximization equations herein to determine optimal cores for each workload. Thus, a user may direct the SoC operational parameters in a fine granularity giving extra control beyond the SoC simply applying the pre-defined voltage/frequency (VF) curves and power states, that is, P0, P1, Pn ratios.

Once the system is operational, the PCM at OS level and system firmware at the SoC level may monitor heuristic factors, for example, the usage metrics using process monitors (PMON's), model specific registers (MSRs), and the like, block 408. System firmware may perform heuristics-based profiling and use predictive mechanisms to apply or tweak the core selection for the running processes while optimizing based on user selection, block 410.

To determine a power optimization solution to maintain operation within the given power budget, the following power optimization equation may be used:

$$Tp = nA * vA * iA + nC * vC * iC$$

where Tp=Total power, nA=# of E-Cores, nC=# of P-Cores, vA=operating voltage of E-Core, vC=operating voltage of P-core, iA=input current to the E-Core, and iC=input current to the P-core.

The power optimization equation is based on the fundamental equation—P=VI and does not consider any impedance/resistance/capacitance, leakage, and the like. According to various embodiments, other equations may be used to represent power usage. For example, both static and dynamic power may be considered. Static power may be represented as P=VI and dynamic as P=cV²F where c is a constant.

To determine a performance maximization solution, the following performance optimization equation may be used:

$$Te = nA * pA + nC * pC$$

where Te=Performance per watt, nA=# of E-Cores, nC=# of P-Cores, pC=performance per watt for E-Core which may be represented as “b*pA” where ‘b’ is a constant scaling factor. Thus, the equation becomes:

$$Te = nA * pA + b * nC * pA$$

$$Te = ( nA + b * nC ) * pA$$

Normalizing pA to 1, the equation becomes:

$$Te = nA + b * nC$$

According to various embodiments, the core utilization, optimization & allocation may be performed at the hardware level, within SoC 308, based on core profiling, rather than by OS 304.

The equations listed herein are example calculations that may be used by OAC 322 and/or PCM 336 to assign workloads to one or more of P-Cores 312 and/or E-Cores 314. Other calculations and/or representations of a core's power/performance profile may be used in accordance with various embodiments.

Various embodiments may include any suitable combination of the above-described embodiments including alternative (or) embodiments of embodiments that are described in conjunctive form (and) above (e.g., the “and” may be “and/or”). Furthermore, some embodiments may include one or more articles of manufacture (e.g., non-transitory computer-readable media) having instructions, stored thereon, that when executed result in actions of any of the above-described embodiments. Moreover, some embodiments may include apparatuses or systems having any suitable means for carrying out the various operations of the above-described embodiments.

The above description of illustrated embodiments, including what is described in the Abstract, is not intended to be exhaustive or to limit embodiments to the precise forms disclosed. While specific embodiments are described herein for illustrative purposes, various equivalent modifications are possible within the scope of the embodiments, as those skilled in the relevant art will recognize.

These modifications may be made to the embodiments in light of the above detailed description. The terms used in the following claims should not be construed to limit the embodiments to the specific implementations disclosed in the specification and the claims. Rather, the scope of the invention is to be determined entirely by the following claims, which are to be construed in accordance with established doctrines of claim interpretation.

### EXAMPLES

The following examples pertain to further embodiments. An example may be an apparatus, comprising a first core; a second core, wherein a power/performance profile of the first core is different from a power/performance profile of the second core; and a core assignment optimizer to select one of the first core and the second core to perform a workload, wherein the core assignment optimizer to select the one of the first core and the second core based on one or more of user preferences, the power/performance profile of the first core, the power/performance profile of the second core, a system power budget, system thermal characteristics, and usage data of the first core and the second core.

An example may include the core assignment optimizer further to perform static and/or heuristic profiling of the first core and the second core.

An example may include at least one storage unit to store the power/performance profile of the first core and the power/performance profile of the second core.

An example may include wherein the user preferences include a voltage and speed setting of the first core to be set by a user.

An example may include wherein the core assignment optimizer to select the first core if the second core has a higher usage level than the first core.

An example may include wherein the first core has higher performance characteristics than the second core and where the second core has lower power usage characteristics than the first core.

An example may include wherein the core assignment optimizer to exclude the user preferences if the user preferences are outside static system parameters.

An example may include a system including an operating system to receive user preferences, the operating system including a processor capabilities manager; a first core; a second core, wherein a power/performance profile of the first core and is different than a power/performance profile of the second core; and a core assignment optimizer communicate with the processor capabilities manager to select one of first core and the second core to perform a workload, wherein the core assignment optimizer to select the one of the first core and the second core based on one or more of the user preferences, the power/performance profile of the first core, the power/performance profile of the second core, a system power budget, system thermal characteristics, and usage data of the first core and the second core.

An example may include the core assignment optimizer further to perform static and/or heuristic profiling of the first core and the second core.

An example may include at least one storage unit to store the power/performance profile of the first core and the power/performance profile of the second core.

An example may include wherein the user preferences include a voltage and speed setting of the first core to be set by a user.

An example may include wherein the core assignment optimizer to select the first core if the second core has a higher usage level than the first core.

An example may include wherein the first core has higher performance characteristics than the second core and wherein the second core has lower power usage characteristics than the first core.

An example may include wherein the core assignment optimizer to exclude the user preferences if the user preferences are outside static system parameters.

An example may include a method comprising determining and communicating system capabilities; obtaining user preferences; and performing static core profiling and assigning a workload to a first core, wherein the assigning is based on the user preferences and results of the static core profiling.

An example may include wherein the determining and communicating system capabilities includes determining system configuration including a total number of cores and the type of cores, and storing the system configuration in a storage unit.

An example may include wherein the user preferences include a voltage and speed setting of the first core to be set by a user.

An example may include wherein the performing the static core profiling includes determining a power and performance profile of the first core based on varying workloads and operating conditions.

An example may include monitoring system conditions; performing heuristic core profiling based on the system conditions; and reassigning the workload to a second core, wherein the reassigning is based on the user preferences and results of the heuristic core profiling.

An example may include wherein the system conditions monitored include one of current thermal conditions, current resource availability, and usage statistics of the first core and the second core.

Another example may include an apparatus comprising means to perform one or more elements of a method described in or related to any of examples herein, or any other method or process described herein.

Another example may include one or more non-transitory computer-readable media comprising instructions to cause an electronic device, upon execution of the instructions by one or more processors of the electronic device, to perform one or more elements of a method described in or related to any of examples herein, or any other method or process described herein.

Another example may include an apparatus comprising logic, modules, or circuitry to perform one or more elements of a method described in or related to any of examples herein, or any other method or process described herein.

Another example may include a method, technique, or process as described in or related to any of examples herein, or portions or parts thereof.

Another example may include an apparatus comprising: one or more processors and one or more computer readable media comprising instructions that, when executed by the one or more processors, cause the one or more processors to perform the method, techniques, or process as described in or related to any of examples herein, or portions thereof.

Another example may include a signal as described in or related to any of examples herein, or portions or parts thereof.

Understand that various combinations of the above examples are possible.

Note that the terms “circuit” and “circuitry” are used interchangeably herein. As used herein, these terms and the term “logic” are used to refer to alone or in any combination, analog circuitry, digital circuitry, hard wired circuitry, programmable circuitry, processor circuitry, microcontroller circuitry, hardware logic circuitry, state machine circuitry and/or any other type of physical hardware component. Embodiments may be used in many different types of systems. For example, in one embodiment a communication device can be arranged to perform the various methods and techniques described herein. Of course, the scope of the present invention is not limited to a communication device, and instead other embodiments can be directed to other types of apparatus for processing instructions, or one or more machine readable media including instructions that in response to being executed on a computing device, cause the device to carry out one or more of the methods and techniques described herein.

Embodiments may be implemented in code and may be stored on a non-transitory storage medium having stored thereon instructions which can be used to program a system to perform the instructions. Embodiments also may be implemented in data and may be stored on a non-transitory storage medium, which if used by at least one machine, causes the at least one machine to fabricate at least one integrated circuit to perform one or more operations. Still further embodiments may be implemented in a computer readable storage medium including information that, when manufactured into a SoC or other processor, is to configure the SoC or other processor to perform one or more operations. The storage medium may include, but is not limited to, any type of disk including floppy disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. An apparatus:
a first core;
a second core, wherein a power/performance profile of the first core is different from a power/performance profile of the second core; and
a core assignment optimizer to select one of the first core and the second core to perform a workload, wherein the core assignment optimizer to select the one of the first core and the second core based on one or more of user preferences, the power/performance profile of the first core, the power/performance profile of the second core, a system power budget, system thermal characteristics, and usage data of the first core and the second core.

2. The apparatus of claim 1, the core assignment optimizer further to perform heuristic profiling of the first core and the second core.

3. The apparatus of claim 1, further comprising at least one storage unit to store the power/performance profile of the first core and the power/performance profile of the second core.

4. The apparatus of claim 1, wherein the user preferences include a voltage and speed setting of the first core to be set by a user.

5. The apparatus of claim 1, wherein the core assignment optimizer to select the first core if the second core has a higher usage level than the first core.

6. The apparatus of claim 1, wherein the first core has higher performance characteristics than the second core and wherein the second core has lower power usage characteristics than the first core.

7. The apparatus of claim 1, wherein the core assignment optimizer to exclude the user preferences if the user preferences are outside static system parameters.

8. A system comprising:
an operating system to receive user preferences, the operating system including a processor capabilities manager;
a first core;
a second core, wherein a power/performance profile of the first core is different from a power/performance profile of the second core; and
a core assignment optimizer to communicate with the processor capabilities manager to select one of the first core and the second core to perform a workload, wherein the core assignment optimizer to select the one of the first core and the second core based on one or more of the user preferences, the power/performance profile of the first core, the power/performance profile of the second core, a system power budget, system thermal characteristics, and usage data of the first core and the second core.

9. The system of claim 8, the core assignment optimizer further to perform heuristic profiling of the first core and the second core.

10. The system of claim 8, further comprising at least one storage unit to store the power/performance profile of the first core and the power/performance profile of the second core.

11. The system of claim 8, wherein the user preferences include a voltage and speed setting of the first core to be set by a user.

12. The system of claim 8, wherein the core assignment optimizer to select the first core if the second core has a higher usage level than the first core.

13. The system of claim 8, wherein the first core has higher performance characteristics than the second core and wherein the second core has lower power usage characteristics that the first core.

14. The system of claim 8, wherein the core assignment optimizer to exclude the user preferences if the user preferences are outside static system parameters.

15. A method comprising:
determining and communicating system capabilities;
obtaining user preferences;
performing static core profiling; and
assigning a workload to a first core, wherein the assigning is based on the user preferences and results of the static core profiling.

16. The method of claim 15, wherein the determining and communicating system capabilities includes determining system configuration including a total number of cores and the type of cores, and storing the system configuration.

17. The method of claim 15, wherein the user preferences include a voltage and speed setting of the first core to be set by a user.

18. The method of claim 15, wherein the performing the static core profiling includes determining a power and performance profile of the first core based on varying workloads and operating conditions.

19. The method of claim 15, further comprising monitoring system conditions; performing heuristic core profiling based on the system conditions; and reassigning the workload to a second core, wherein the reassigning is based on the user preferences and results of the heuristic core profiling.

20. The method of claim 19, wherein the system conditions monitored include one of current thermal conditions, current resource availability, and usage statistics of the first core and the second core.
